(19) United States
(12) Patent Application Publication
(10) Pub. No.: US 2004/0008574 A1
(43) Pub. Date: Jan. 15, 2004

(54) Propeller for stirring solid-in-liquid suspensions in a treatment tank

(76) Inventors: Franco Aver, Valli Del Pasubio (VI) (IT); Franco Nardi, Torviscosa (UD) (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/390,158

(22) Filed: Mar. 18, 2003

(30) Foreign Application Priority Data
Mar. 19, 2002 (IT) VI2002A000048

(51) Int. Cl. B01F 7/24

(52) U.S. Cl. 366/266; 366/307; 366/323; 366/329.1

(57) ABSTRACT

A propeller for stirring solid-in-liquid suspensions inside a treatment tank is disclosed, comprising a generally axial element consisting of at least a blade with helical development and a generally radial element consisting of a plurality of vanes with generally radial development. Said elements belong to a single central shaft defining a longitudinal rotation axis along which said elements are coaxially arranged one after the other.

The invention relates to a propeller for stirring solid-in-liquid suspensions within a treatment tank.

The propeller is particularly adapted to be used in paper industry to prepare paper pulps.

It is well known that one of the problems that the chemical and similar industries have frequently to solve, is to obtain homogenous solutions or suspensions, spreading solids and chemical reagents in the masses to be treated, more particularly in the masses with high concentration, so as to make the product uniform and accelerate the reactions.

The solution often consists in causing strong agitations or channeled motions with the related mass transfers that jointly with proper temperatures and pressures optimize the reactions.

These problems characterize specifically the cellulose and paper industry that in the various technological applications turns to the following measures:

operations of pulping cellulose with long and short fibers purchased on the market in the form of bales consisting of dried sheets;

separation into elementary fibers in the process of recycling scraps of paper and paper board, especially when ink removal is required;

creation of mass transfer required by delignification reactions, according to which the cellulose fibers in an aqueous suspension are brought to reaction with chemical substances and in the most advanced processes with gaseous reactants such as O2 or O3 under conditions of medium-high temperatures varying from 70 to 200° C. and corresponding steam pressures.

These operations are presently carried out by propellers of various shapes creating uncontrolled motions with consequent high energy consumption.

The installed power is even higher than 200 kW per ton of product present in the container in which the propeller is operating and this high quantity of installed power is mostly required by non organized and channeled motions and the impact of the product under treatment against the surface of the container and the propeller creating inefficient turbulence.

It is known that in the cellulose and paper industry propellers are used, consisting mainly of a central shaft with a helical or centrifugal impeller keeping the fibrous materials moving in a liquid suspension having a concentration of suspended solids varying from 1 to 6% in the low concentration pulpers while it may vary from 6 to 15% in the high concentration pulpers.

The action carried out by said equipments consists only in separating the cellulose or scrap fibers and to make homogeneous their suspension in the liquid so as to allow their use in the subsequent paper manufacturing processes.

In the frame of said actions, it is important the operation of separating the ink so as to allow recovery of fibers free from pollution due to said ink.

These specific actions are carried out by an impeller that rotating inside a container causes the mass to be stirred when separation into elementary fibers occurs by the rubbing action between adjacent fibers, said action being a function of time the other conditions being equal.

The known propellers of the above mentioned kind, in their constructional form allowing their most general use, consist of two superposed impellers developed on a vertical plane and connected to two axes causing them to rotate with different angular velocity.

Said propellers however have some recognized drawbacks.

A first drawback consists in that a considerable portion of the material flow occurs by non channeled and organized motions and with strong impact against the wall of the container causing a decrease of efficiency and high energy consumption.

Another drawback consists in that their specific constructional shape limits their efficiency to concentrations between 2 to 6% and 6 to 15%.

A further drawback consists in that their construction and operation limits their use to non pressurized containers, consequently with an operation to temperatures not exceeding 100° C.

The present invention aims at overcoming said drawbacks and limitations.

More particularly the purpose is to provide a propeller having as main object to be efficient both at low and high concentration of the fibrous suspensions, therefore with concentrations varying from 2 up to 20%.

Another object of the invention is to provide a propeller causing channeled and organized motion of the fluidic filaments avoiding violent impacts and acting synergistically with the natural motions arising from any action of mechanical thrust in the mass and/or the convective motions arising from the mass heating.

A further object of the invention is to provide a propeller having considerably lower energy consumption in comparison with the propellers of the prior art. Another object is to provide a propeller that can be used in containers of various shapes and capacity between 5 and 100 m³.

A further object of the invention is to provide a propeller reducing the working time in comparison with the propellers of the prior art, the quality of the final product being equal.

The above mentioned- objects are attained by a propeller for stirring solid-in-liquid suspensions inside a treatment tank that according to the main claim is characterized by comprising:

a generally axial element consisting of at least a blade with a helical development;

a generally radial element consisting of a plurality of vanes with generally radial development, said elements belonging to a single central shaft defining a longitudinal rotation axis along which said elements are coaxially arranged one after the other and said generally axial element of said propeller having a frustum-conical shape converging to the bottom of said tank.

The propeller of the invention operates inside a treatment tank provided with a bladed plate arranged at the bottom, from which the central shaft is vertically extended.

The generally radial element of the propeller is facing said bladed plate.

According to a preferred constructional embodiment to be described hereinafter, the generally radial element of the propeller comprises a plurality of radial vanes fixed to the central shaft while the generally axial element comprises a single helical blade wound on the same central shaft.

In other embodiments the generally axial element may comprise more than one helical blade.

Advantageously use of the propeller of the invention allows in view of the principle of motion rationalization, all the other conditions and efficiencies being equal, to install a power being even less than 50% relative to the power required by the propellers of the prior art.

Still advantageously the propeller of the invention promotes dispersion into the liquid fibrous suspension of the reactants when they are solubilizable solids as well as soluble or insoluble liquids or gases, so as to create a homogeneous mass.

In another advantageous way the propeller promotes and optimizes said effects and allows to operate under conditions of medium-high temperatures warranting heat distribution in view of the channeled and organized motions generated by the propeller.

More particularly when gases are involved in the reaction, this may be activated or accelerated by the pressure conditions under which the propeller may operate. Indeed operation of the propeller is possible up to pressures of 20 bars with temperature up to 200° C. in view of the peculiar structure of the active parts and the hydraulically balanced and cooled gland.

Advantageous use of the propeller of the invention promotes separation into elementary fibers mainly because of the friction between fibers generated inside the organized flows causing entrainment of each fibrous element sliding relative to the adjacent ones.

Such an operative mode, integrated by reduction of impacts against the container walls, reduces production of fines and the related loss of mechanical features and treated fibrous material.

In a particularly advantageous way use of the propeller of the invention is efficient in treating paper scraps and specifically to obtain separation of ink from the cellulose fibers being the feature of the ink removal process.

Still advantageously a preferred constructional embodiment provides that the generally axial element of the propeller comprises a single helical blade extending on about two thirds of the central shaft length; in this way it is possible to stir masses preferably but not necessarily consisting of suspensions in water or solutions of reactants of solid and/or cellulose fibers with concentrations varying up to 20%.

Advantageously the helical blade of the propeller has a small angle of inclination to the horizontal and this confers to the propeller the ability to work with better efficiency stocks with higher concentration relative to those that can be worked with propellers of the prior art having the same dimensions.

Still advantageously it is possible to reduce, the diameter being equal, the number of revolutions of the propeller still obtaining performances comparable to those of the propellers of the prior art.

The foregoing objects and corresponding advantages will be better understood by reading the following description of a preferred embodiment of the propeller of the invention making references to the accompanying sheets of drawing in which:

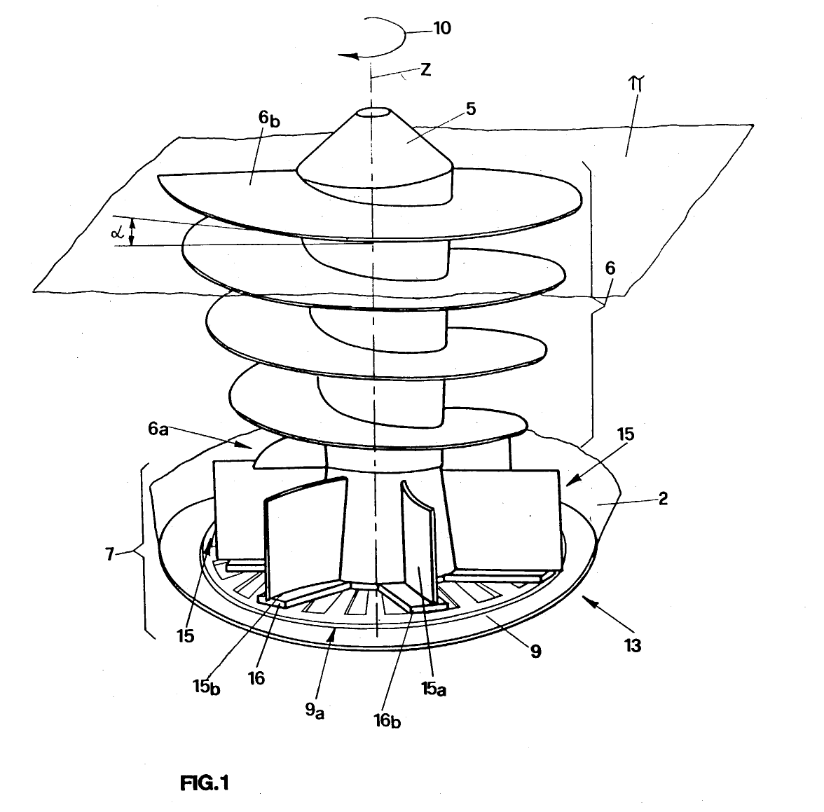

FIG. 1 is an isometric view of the propeller of the invention; and

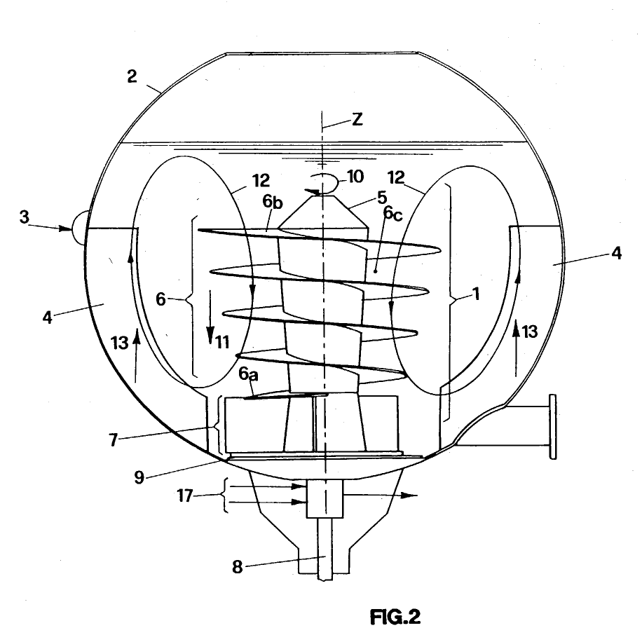

FIG. 2 is a longitudinal sectional view of the propeller of FIG. 1 arranged inside a treatment tank of spherical shape.

The propeller of the invention is shown in FIGS. 1 and 2 where it is indicated generally with references numeral 1.

One can see that the propeller comprises a generally axial part 6 and a generally radial part 7 that are coaxially arranged one after the other.

The generally radial part 7 is arranged between the end portion 6a of the generally axial part 6 and the bottom 9 of the tank 2 containing the propeller 1.

More particularly one can see that the tank 2 has a spherical shape optimizing the treatments carried out by the propeller during rotation.

However it is to be noted that the tank may have any suitable shape such as cylindrical, frustum-conical or other shape. The axial part 6 of the propeller is defined by a helical blade 6b with constant pitch, that is wound for about ⅔ of the length on the peripheral surface of a central shaft 5 defining the rotation axis Z of the propeller.

It is also to be noted that the axial part 6 has a longitudinal frustum-conical profile converging to the generally radial part 7 and therefore the bottom 9 of the tank 2 with the helical blade 6b inclined relative to horizontal plane π at a very small angle a that is preferably but not necessarily comprised between 5° and 25°.

Such an angle of inclination a is much smaller than the angles according to which the helical blades of the propellers of the prior art are made and this confers to the propeller 1 of the invention a great ability to convey high concentration suspensions.

The helical blade 6b has a constant pitch and a single start but in different embodiments it could also have more threads and/or variable pitches.

With regard to the generally radial part 7, one can see that it comprises a plurality of vanes 15 that are radially fixed to the same central shaft 5 on which also the helical blade 6b is wound, and each vane has a curved shape whose convexity 15a is facing the direction of rotation 10 of the propeller.

One can also see that at the edge 15b of each vane 15 arranged at the end of the central shaft 5 and facing the bottom 9 of the tank 2, a flat member 16 projecting from both sides of the vane is applied, so that the vane takes a generally T shaped profile when observed in cross section.

The function of the flat member 16 is to ensure when needed, dimensional reduction of the solid portions of the suspension, since the edge 16b arranged in the motion direction carries out a scissor-like cutting action against the profiles of a bladed plate 9a fixed to the tank bottom 9.

The propeller 1 is put in a clockwise rotation indicated by arrow 10 by a driving unit, preferably but not necessarily consisting of an electric gear motor keyed to the central axis 5.

The driving unit may also be constituted by a hydraulically motor with related pump.

The axis is protected against penetration (leakage) of suspension portions by a gland 8 that when used in pressurized containers at high temperature, is provided with cooling and hydraulically balance 17 of pressure inside the container 2.

In operation during rotation of the propeller 1, the material under treatment as shown in FIG. 2, is channeled and conveyed downwards according to the direction indicated by arrow 11 along the helical duct 6c defined by the helical blade 6b of the axial part 6 until it reaches the radial part 7.

The rotation of said part conveys the material firstly to the peripheral surface of the tank 2 and then upwards according to the direction indicated by arrow 13.

In order to avoid that the material is being rotated in the same direction of the propeller 1, the tank 2 is internally provided with baffles 4 of a plain and/or curved shape, preferably but not necessarily arranged at 30° to each other and adapted to contrast rotation of the material being worked.

A constructional variation provides for use of the propeller in tanks 2 with a temperature higher than the room temperature and under steam and/or gas pressure. In such a case the baffles are made with inner channels fed with steam or other heat carrier 3 and being licked by the moving mass, are behaving as the elements of a heat exchanger thus heating the mass under treatment.

The motions transferred to the aqueous suspension are caused by the axial part 6 of the propeller conveying the material downwards in the direction of arrow 11, until it reaches the radial part 7 that in combination with the action of dimensional reduction given by the flat members 16 acting on the bladed plate 9a, takes the suspension again upwards in the direction indicated by arrow 13 so as to reach again the upper portion of the axial part 6.

In this way the fibrous suspension undergoes a downward movement inside the axial part 6 and then an upward movement in the gap between the axial part 6 and the tank wall 2.

All together an elliptical continuous movement 12 diagrammatically shown in FIG. 2 is obtained, developed on the vertical plane and in view of the peculiar arrangement of the baffles 4, causes channeled and organized crescent-like movements.

More particularly the baffles 4 have a plain or curved surface and are fixed to the tank wall, angularly spaced one to the other for a constant quantity preferably but not necessarily of 30°.

The downward converging frustum-conical shape of the axial part 6 and the small angle of inclination a to the horizontal of the helical blade 6b promote the elliptical movement 12 of the fibrous suspension shown in FIG. 2.

Advantageously this allows to treat suspensions with concentrations that may reach and even exceed 20% and therefore higher than those obtainable with the known stirring devices.

The propeller 1 moves the fibrous mass according to channeled motions in synergy with those caused by other actions, such as the convective motions due to mass heating. Moreover the possibility to move greater quantities of suspension with reduce angular velocity in comparison with conventional propellers and lower impacts against the container walls, attains an energy saving so that the installed power may be considerably lower even beyond 50% relative to propellers of the prior art with equivalent output.

The channeled motions, the lower treatment time and reduced impacts attain a lower wear of the impeller and the container relative to what occurs with the propellers of known type.

The propeller 1 is put in rotation at a velocity varying from 50 to 150 rpm also as a function of its diameter, through actuators of known type that may indifferently consist of gear motors, hydraulically motors and/or motors provided with belt transmission.

The spherical shape of the container given as an illustrative but non limiting example, is associated to the propeller of the invention, more particularly to operate at high temperature (up to 200° C.), and pressures corresponding to saturated steam.

The spherical shape for its geometrical characteristics ensures indeed the maximum volume relative to the surface of the container and the minimum thickness relative to the operative pressures needed by the treatment.

The spherical shape of the tank allows also a better guide of the fibrous suspension in the phase of upwards and downwards movement, because the curved shape of the inner wall of the container guides the suspension during the entire elliptical movement 12.

In view of the foregoing one can understand that the propeller of the invention attains all the intended objects.

It is obvious that in the constructional stage the assembly of propeller and container may be carried out also with shapes different from the disclosure and in any dimension as a function of the user's requirements.

It is to be understood that such possible variations when falling within the scope of the appended claims, are to be considered protected by the present patent.

1) A propeller for stirring solid-in-liquid suspension inside a treatment tank comprising:
a generally axial element having a blade with helical development;
a generally radial element having a plurality of vanes with generally radial development, said elements located on a single central shaft defining a longitudinal rotation axis (Z) along which said elements are coaxially arranged one after the other and said generally axial element of said propeller having a frustro-conical shape converging to the bottom of said tank.

2) A tank according to claim 1, comprising a bladed plate arranged at the bottom to which said generally radial element of said propeller is facing, said central shaft of the propeller being vertically extended from said bottom of said tank.

3) The tank according to claim 1 wherein said generally radial element comprises a plurality of radial vanes fixed to said central shaft, each radial vane having a curved shape with convexity facing the direction of rotation of said propeller.

4) The tank according to claim 2 wherein said bladed plate cooperates with a flat member provided on the edge of each radial vane of said propeller and facing said bladed plate.

5) The tank according to claim 4 wherein each of said flat members is projecting at both sides from the corresponding radial vane having a T shape when seen in cross section.

6) The tank according to claim 1 wherein said generally axial element is developed for at least half the length of said central shaft.

7) The tank according to claim 6 wherein said at least a helical blade is inclined relative to a horizontal plane at an angle between 5° and 25°.

8) The tank according to claim 1 wherein said central shaft is coupled to driving means adapted to put it into rotation at a velocity between 50 and 150 rpm.

9) The tank according to claim 2 wherein it has baffles applied to the internal lateral surface of said tank and projecting inside said tank.

10) The tank according to claim 9 wherein said baffles have a plain surface.

11) The tank according to claim 9 wherein said baffles have a curved surface.

12) The tank according to claim 9 wherein said baffles are spaced angularly one to the other at an angle of 30°.

13) The tank according to claim 9 wherein one or more of said baffles have inner channels connected to heat carriers.

14) The tank according to claim 2, having a spherical shape.

15) The tank according to claim 2, having a cylindrical shape.
